(19) United States
(12) Patent Application Publication
(10) Pub. No.: US 2020/0063874 A1
(43) Pub. Date: Feb. 27, 2020

(54) BALL VALVE SEALING ARRANGEMENT

(71) Applicant: Bridon Industries, Inc., Shakopee, MN (US)

(72) Inventors: CRAIG L. PETERSON, Carver, MN (US); Todd R. Becken, Carver, MN (US)

(21) Appl. No.: 16/550,157

(22) Filed: Aug. 23, 2019

Related U.S. Application Data
(60) Provisional application No. 62/722,791, filed on Aug. 24, 2018.

(51) Int. Cl. F16K 5/06; F16K 11/02

(52) U.S. Cl. CPC F16K 5/0605; F16K 5/0626; F16K 11/025

(57) ABSTRACT

A ball valve sealing arrangement includes a ball element, and a ball seal assembly to support the ball element. The ball seal assembly includes an O-ring and a ball seat, with the ball seat having an O-ring gland in one side and a recess in an opposite side, the O-ring gland to receive the O-ring and the recess to receive the ball element, and an outer dimension of the O-ring gland being within an outer dimension of the recess.

### CROSS-REFERENCE TO RELATED APPLICATIONS

This application claims priority under 35 U.S.C. § 119(e) to U.S. Provisional Patent Application Ser. No. 62/722,791 filed on Aug. 24, 2018, and incorporated herein by reference.

### BACKGROUND

The present disclosure relates generally to a ball valve and, more specifically, relates to a ball valve sealing arrangement.

### BRIEF DESCRIPTION OF THE DRAWINGS

FIG. 1 is an exploded perspective view of an example of a ball valve in accordance with the present disclosure.

FIG. 2 is an assembled cross-sectional view of the ball valve of FIG. 1 in an open position.

FIG. 3 is an assembled cross-sectional view of the ball valve of FIG. 1 in a closed position.

FIG. 4 is an enlarged view of the area within the broken line circle of FIG. 3.

FIG. 5 is a cross-sectional view of an example of a ball seat of the ball valve of FIG. 1.

FIG. 6 is a perspective view of an O-ring side of the ball seat of FIG. 5.

FIG. 7 is a perspective view of a ball-side of the ball seat of FIG. 5.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

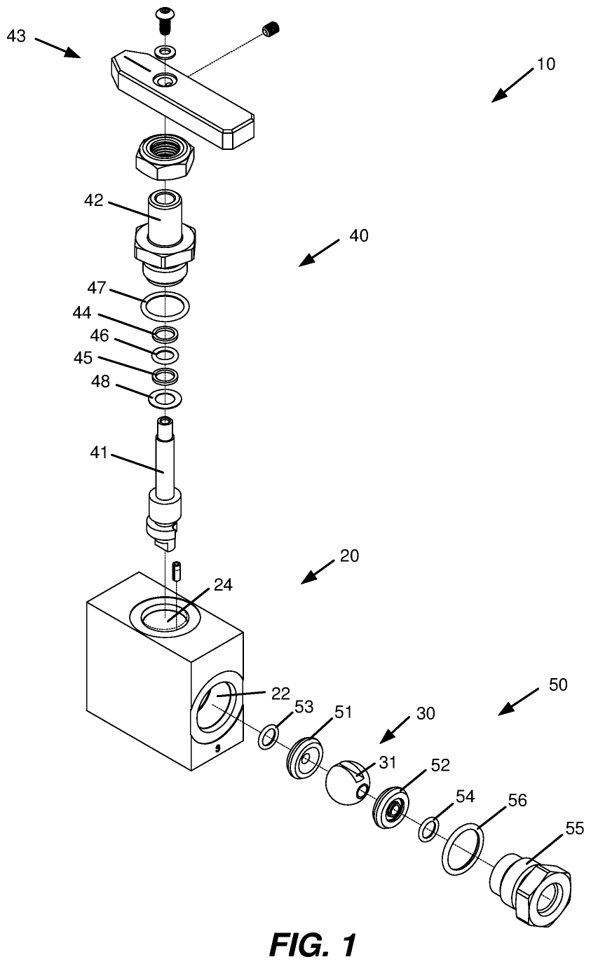

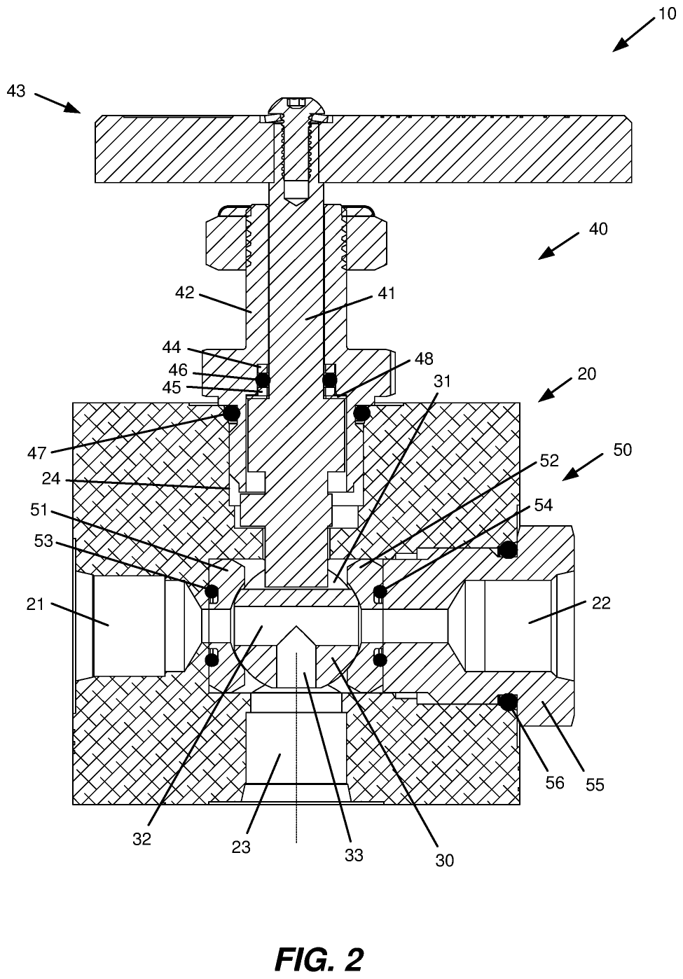

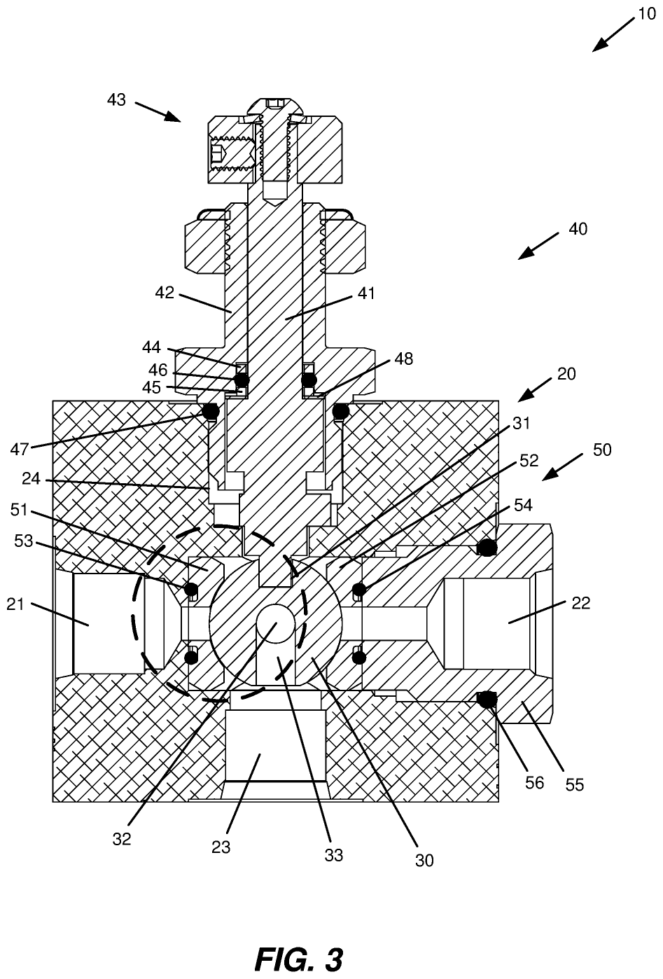

FIG. 1 is an exploded perspective view of an example of a ball valve 10 in accordance with the present disclosure. In addition, FIG. 2 is an assembled cross-sectional view of ball valve 10 in an open position, and FIG. 3 is an assembled cross-sectional view of ball valve 10 in a closed position. In one example, ball valve 10 includes a valve body 20, a ball element 30, an actuator assembly 40, and a ball seal assembly 50. As described herein, ball element 30 is supported within valve body 20 by ball seal assembly 50, and actuator assembly 40 extends into valve body 20 to engage and control ball element 30.

In the illustrated example, valve body 20 includes ports 21, 22, and 23, and an actuator opening 24. In addition, in the illustrated example, actuator assembly 40 includes a shaft 41, a shaft retainer 42, and a handle kit 43. As such, shaft 41 of actuator assembly 40 extends into actuator opening 24 of valve body 20 and engages a keyway or slot 31 of ball element 30 such that actuator assembly 40 may rotate and control an orientation of ball element 30. In the illustrated example, backup rings 44 and 45 and an O-ring 46 seal and support shaft 41 within shaft retainer 42, and an O-ring 47 and washer 48 seal and support shaft retainer 42 within actuator opening 24 of valve body 20 and support shaft retainer 42 on shaft 41, respectively.

In the illustrated example, ball seal assembly 50 includes ball seats 51 and 52, O-rings 53 and 54, retainer 55, and O-ring 56. Ball seats 51 and 52 are positioned on opposite sides of ball element 30, and O-rings 53 and 54 are supported by respective ball seats 51 and 52 such that ball seats 51 and 52 seal and support ball element 30 within valve body 20, and O-rings 53 and 54 seal and support respective ball seats 51 and 52 within valve body 20.

In the illustrated example, ball valve 10 is a three-way ball valve incorporating two ball valve seats, namely, ball seat 51 and ball seat 52. In other examples, one or more than one ball valve seat, as disclosed herein, may be incorporated in other ball valve arrangements or other ball valves such as, for example, a two-way ball valve or a four-way ball valve.

As illustrated in the example of FIG. 2, ball element 30 has a port, passage, or opening 32 extended therethrough between opposite sides of ball element 30, and has a port, passage, or opening 33 extended into ball element 30 and communicated with opening 32 from a side orthogonal to the opposite sides of ball element 30. Thus, based on a rotational position of ball element 30, fluid may or may not pass through ports 21, 22, and/or 23 of valve body 20. For example, as illustrated in the example of FIG. 2, ball valve 10 is in an open position such that fluid may pass through ports 21, 22, and/or 23, and as illustrated in the example of FIG. 3, ball valve 10 is in a closed position such that fluid may not pass through ports 21, 22, and/or 23.

In the illustrated example, ball seats 51 and 52 are the same, and O-rings 53 and 54 are the same. As such, disclosure (description and illustration) of ball seat 51 and O-ring 53 herein is also applicable to ball seat 52 and O-ring 54.

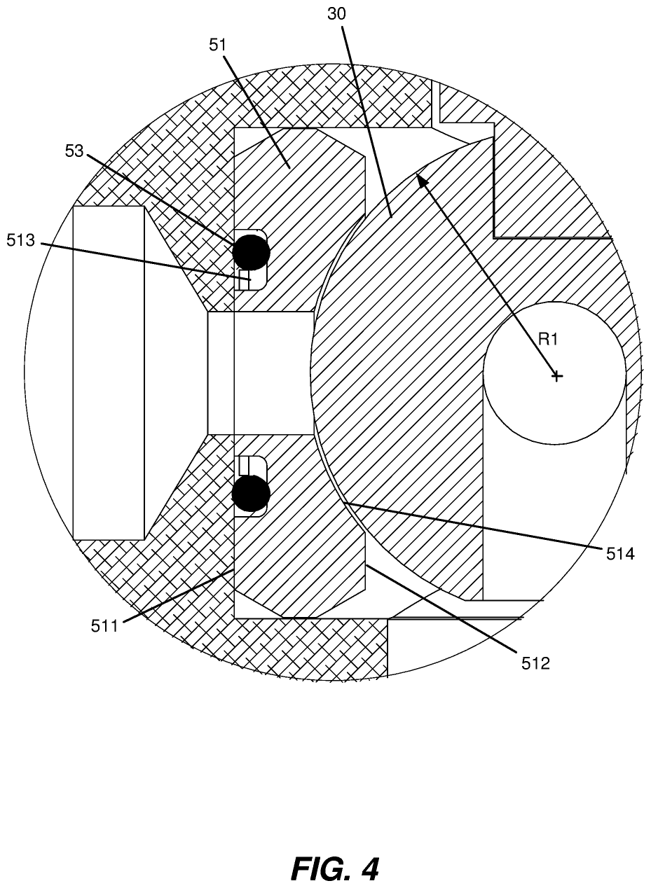

As illustrated in the example of FIG. 4, ball seat 51 has an O-ring side 511 and a ball side 512 opposite O-ring side 511. As such, O-ring side 511 of ball seat 51 includes an O-ring gland 513 to receive O-ring 53 such that O-ring 53 is fit within and/or supported within O-ring gland 513 on O-ring side 511 of ball seat 51. In addition, ball side 512 of ball seat 51 includes a recess 514 to receive (a portion of) ball element 30 such that ball element 30 extends into and/or is supported within recess 514 on ball side 512 of ball seat 51. Although illustrated with a slight gap between ball element 30 and ball seat 51, under fluid pressure, ball element 30 contacts and seals against ball seat 51 within recess 514 and/or ball seat 51 contacts and seals against ball element 30.

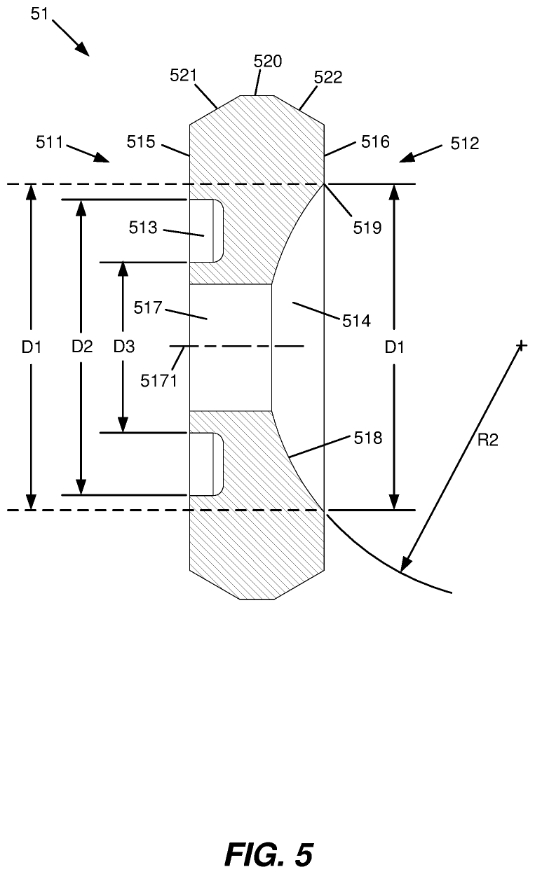

FIG. 5 is a cross-sectional view of an example of ball seat 51. In the illustrated example, ball seat 51 has a face 515 on O-ring side 511, and a face 516 on ball side 512. As such, O-ring gland 513 is included (provided, formed) in and/or communicated with face 515 on O-ring side 511, and recess 514 is included (provided, formed) in and/or communicated with face 516 on ball side 512. In the illustrated example, ball seat 51 has a port, passage, or opening 517 extended therethrough which communicates with recess 514 such that opening 517 communicates with both O-ring side 511 and ball side 512 (via recess 514). As such, in the open position of ball valve 10 (FIG. 2), opening 517 of ball seat 51 communicates with opening 32 of ball element 30.

In the illustrated example, recess 514 includes an arcuate surface 518 extended between face 516 of ball side 512 and opening 517. In one implementation, recess 514 comprises a truncated spherical surface or spherical zone. In one example, ball element 30 has a radius R1 (FIG. 4) and recess 514 of ball seat 51 has a radius R2 (FIG. 5) such that, in one implementation, radius R1 of ball element 30 is less than radius R2 of recess 514.

In the illustrated example, recess 514 has an outer dimension (outer diameter) D1 at a boundary or interface 519 with face 516. In addition, O-ring gland 513 has an outer dimension (outer diameter) D2 and an inner dimension (inner diameter) D3. As such, in one implementation, outer dimension D2 of O-ring gland 513 is within outer dimension D1 of recess 514. More specifically, outer dimension D2 of O-ring gland 513 is less than outer dimension D1 of recess 514 and, in a direction perpendicular to axis 5171 of opening 517, outer dimension D2 of O-ring gland 513 is positioned within an extent of outer dimension D1 of recess 514 as projected in a direction parallel with axis 5171 (as indicated by broken lines).

In the illustrated example, ball seat 51 has an outer annular surface 520 with, in one implementation, chamfered surfaces 521 and 522 extended between outer annular surface 520 and face 515 of O-ring side 511, and outer annular surface 520 and face 516 of ball side 512, respectively. In another implementation, chamfered surfaces 521 and 522 are excluded such that outer annular surface 520 forms substantially orthogonal corners with face 515 of O-ring side 511 and face 516 of ball side 512.

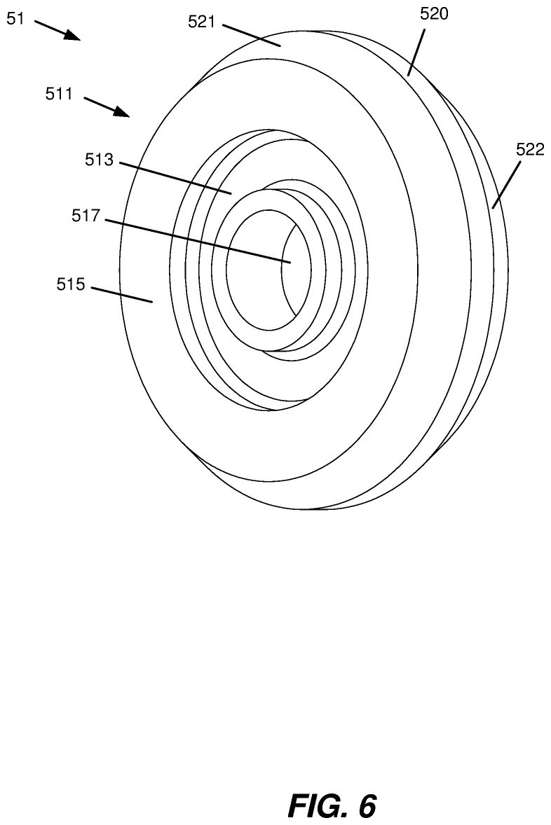

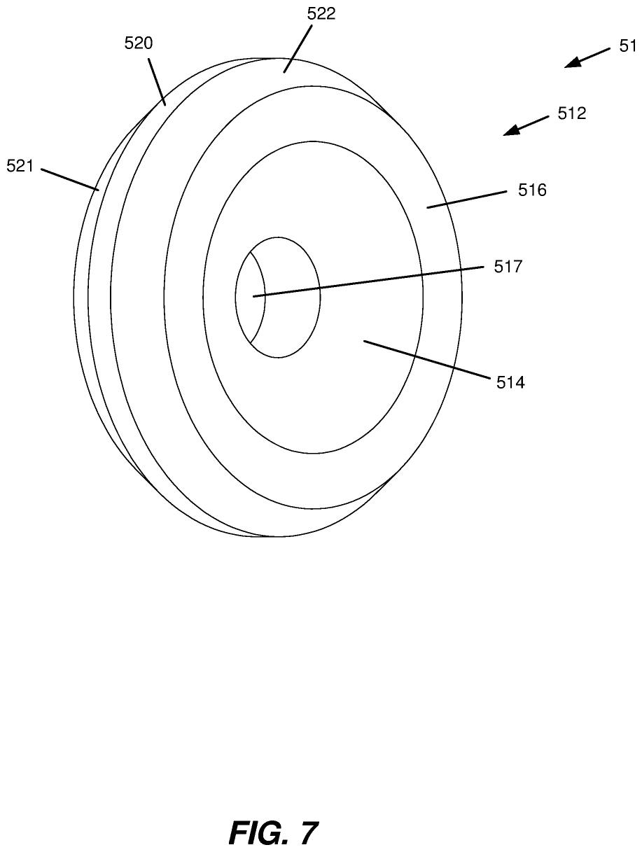

FIG. 6 is a perspective view of O-ring side 511 of ball seat 51, and FIG. 7 is a perspective view of ball side 512 of ball seat 51. As such, FIG. 6 illustrates, for example, opening 517, O-ring gland 513, face 515, chamfered surface 521, outer annular surface 520, and chamfered surface 522, and FIG. 7 illustrates, for example, opening 517, recess 514, face 516, chamfered surface 522, outer annular surface 520, and chamfered surface 521.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A ball valve sealing arrangement, comprising:
a ball element; and
a ball seal assembly to support the ball element,
the ball seal assembly including an O-ring and a ball seat, the ball seat having an O-ring gland in one side and a recess in an opposite side,
the O-ring gland to receive the O-ring and the recess to receive the ball element,
an outer dimension of the O-ring gland being within an outer dimension of the recess.

2. The ball valve sealing arrangement of claim 1, the outer dimension of the O-ring gland being less than the outer dimension of the recess.

3. The ball valve sealing arrangement of claim 1, the ball seat having an opening extended therethrough, the opening communicated with the recess.

4. The ball valve sealing arrangement of claim 3, the outer dimension of the O-ring gland being positioned within an extent of the outer dimension of the recess as projected in a direction parallel with an axis extended through the opening.

5. The ball valve sealing arrangement of claim 3, the recess including an arcuate surface extended between a face of the ball seat and the opening extended through the ball seat.

6. The ball valve sealing arrangement of claim 1, a radius of the ball element being less than a radius of the recess.

7. The ball valve sealing arrangement of claim 1, further comprising:
a valve body, the ball element supported within the valve body by the ball seal assembly; and
an actuator assembly, the actuator assembly extended into the valve body to engage and control the ball element.

8. A ball valve seat, comprising:
a body including an O-ring gland on one side and a recess on an opposite side, the O-ring gland to support an O-ring, and the recess to support a ball element,
the O-ring gland having an outer diameter less than an outer diameter of the recess.

9. The ball valve seat of claim 8, the body having an opening extended therethrough, the opening communicated with the recess.

10. The ball valve seat of claim 9, the opening having an axis extended therethrough, and, in a direction perpendicular to the axis of the opening, the outer diameter of the O-ring gland being positioned within an extent of the outer diameter of the recess as projected in a direction parallel with the axis of the opening.

11. The ball valve seat of claim 8, the O-ring gland being formed in a face on the one side of the body, and the recess being formed in an opposite face on the opposite side of the body.

12. The ball valve seat of claim 11, the outer diameter of the recess being at a boundary of the recess with the opposite face on the opposite side of the body.

13. The ball valve seat of claim 8, the body comprising an annular body having an outer annular surface.

14. The ball valve seat of claim 8, the recess comprising a truncated spherical surface.

15. A method of sealing a ball valve, comprising:
supporting a ball element with a ball seat, including supporting an O-ring within an O-ring gland on one side of the ball seat and supporting the ball element within a recess on an opposite side of the ball seat,
an outer dimension of the O-ring gland being within an extent of an outer dimension of the recess.

16. The method of claim 15, the outer dimension of the O-ring gland being less than the outer dimension of the recess.

17. The method of claim 15, the ball seat having an opening extended therethrough, the recess communicated with the opening.

18. The method of claim 17, the outer dimension of the O-ring gland being within the extent of the outer dimension of the recess as projected in a direction parallel with an axis extended through the opening.

19. The method of claim 15, the recess including an arcuate surface.

20. The method of claim 15, a radius of the ball element being less than a radius of the recess.
